(19) United States
(12) Patent Application Publication
(10) Pub. No.: US 2019/0147410 A1
(43) Pub. Date: May 16, 2019

(54) INFORMATION PROCESSING DEVICE AND NON-TRANSITORY COMPUTER-READABLE RECORDING MEDIUM STORING PROGRAM

(71) Applicants: TOYOTA JIDOSHA KABUSHIKI KAISHA, Toyota-shi (JP); AISIN AW CO., LTD., Anjo-shi (JP)

(72) Inventors: Hiroaki TAKEYAMA, Nisshin-shi (JP); Xin JIN, Nagoya-shi (JP); Norihiro NAKAMURA, Toyokawa-shi (JP); Hideki KASEZAWA, Okazaki-shi (JP); Kensuke TAKEUCHI, Okazaki-shi (JP); Hajime MORIKAWA, Nagoya-shi (JP); Yoko SAKURAI, Toyohashi-shi (JP)

(73) Assignees: TOYOTA JIDOSHA KABUSHIKI KAISHA, Toyota-shi (JP); AISIN AW CO., LTD., Anjo-shi (JP)

(21) Appl. No.: 16/191,397

(22) Filed: Nov. 14, 2018

(30) Foreign Application Priority Data
Nov. 16, 2017 (JP) 2017-221307

(51) Int. Cl. G06Q 10/10; G01C 21/20

(52) U.S. Cl. CPC G06Q 10/1097; G01C 21/20

(57) ABSTRACT

An information processing device includes a first acquisition unit configured to acquire, from a user, first action schedule information including a first target place, a first desired arrival time, and a first desired stay time, and second action schedule information including a second target place, a second desired arrival time, and a second desired stay time, a second acquisition unit configured to acquire a first use condition and a second use condition, and a scheduling unit configured to decide a first scheduled time of arrival at the first target place and a second scheduled time of arrival at the second target place such that the first desired arrival time and the first desired stay time satisfy a first usable condition and such that the second desired arrival time and the second desired stay time satisfy a second usable condition.

### INCORPORATION BY REFERENCE

The disclosure of Japanese Patent Application No. 2017-221307 filed on Nov. 16, 2017 including the specification, drawings and abstract is incorporated herein by reference in its entirety.

### BACKGROUND

### 1. Technical Field

The present disclosure relates to an information processing device that notifies a user of information, and a non-transitory computer-readable recording medium storing a program.

### 2. Description of Related Art

There has been known a technique for searching for a route to a target place via a facility set as a via-place in a case where a scheduled time of arrival at the facility falls within usable time of the facility in a navigation device (see, for example, Japanese Unexamined Patent Application Publication No. 2016-156691 (JP 2016-156691 A)).

### SUMMARY

In a case where a user visits a plurality of facilities, a scheduled time of arrival at each facility is necessarily decided such that the user can arrive at each facility within usable time of each facility, but it is not easy to make a plan as described above by using the related art.

The present disclosure provides an information processing device and a non-transitory computer-readable recording medium storing a program which are capable of improving convenience at the time of deciding scheduled times of arrival at a plurality of target places.

A first aspect of the disclosure relates to an information processing device including a first acquisition unit, a second acquisition unit, a third acquisition unit, and a scheduling unit. The first acquisition unit is configured to acquire, from a user, first action schedule information including a first target place, a first desired arrival time when the user desires to arrive at the first target place, and a first desired stay time for which the user stays in the first target place, and second action schedule information including a second target place, a second desired arrival time when the user desires to arrive at the second target place, and a second desired stay time for which the user stays in the second target place. The second acquisition unit is configured to acquire a first use condition of the first target place included in the first action schedule information, and a second use condition of the second target place included in the second action schedule information. The third acquisition unit is configured to acquire a travel time between the first target place and the second target place. The scheduling unit is configured to decide a first scheduled time of arrival at the first target place and a second scheduled time of arrival at the second target place based on the travel time between the first target place and the second target place such that the first desired arrival time and the first desired stay time included in the first action schedule information satisfy a first usable condition derived from the first use condition and such that the second desired arrival time and the second desired stay time included in the second action schedule information satisfy a second usable condition derived from the second use condition.

According to the first aspect of the disclosure, the first scheduled time of arrival at the first target place and the second scheduled time of arrival at the second target place are decided based on the travel time between the first target place and the second target place such that the first desired arrival time and the first desired stay time included in the first action schedule information satisfy the first usable condition derived from the first use condition and such that the second desired arrival time and the second desired stay time included in the second action schedule information satisfy the second usable condition, and thus it is possible to easily and appropriately decide the first scheduled time of arrival at the first target place and the second scheduled time of arrival at the second target place. Therefore, it is possible to improve convenience at the time of deciding scheduled times of arrival at a plurality of target places.

In the first aspect of the disclosure, the second action schedule information may further include change prohibition information of the second desired arrival time. The scheduling unit may decide the second desired arrival time as the second scheduled time of arrival, and decides the first scheduled time of arrival of the first target place instead of the first desired arrival time of the first target place, without changing the second desired arrival time of the second target place included in the second action schedule information including change prohibition information of the second desired arrival time.

In the first aspect of the disclosure, the first action schedule information may further include change prohibition information of scheduled times of arrival at via-places before and after the first target place, in a course toward the first target place included in the first action schedule information. The scheduling unit may decide the scheduled time of arrival at the first target place without changing the scheduled times of arrival at the via-places.

In the first aspect of the disclosure, the first action schedule information may further include change prohibition information of scheduled times of arrival at via-places before and after the first target place, in a course toward the first target place included in the first action schedule information. The scheduling unit may decide the first scheduled time of arrival at the first target place and the second scheduled time of arrival at the second target place without changing the scheduled times of arrival at the via-places.

In the first aspect of the disclosure, the scheduling unit may decide the first scheduled time of arrival at the first target place and the second scheduled time of arrival at the second target place such that a sum of the travel times between the first target place and the second target place is minimized.

In the first aspect of the disclosure, in a case where the scheduling unit is not able to decide the first scheduled time of arrival at the first target place and the second scheduled time of arrival at the second target place such that the first desired arrival time and the first desired stay time included in the first action schedule information satisfy the first usable condition derived from the first use condition and such that the second desired arrival time and the second desired stay time included in the second action schedule information satisfy the second usable condition derived from the second use condition, the scheduling unit may decide the first scheduled time of arrival at the first target place and the second scheduled time of arrival at the second target place such that the sum of the travel times between the first target place and the second target place is minimized.

In the first aspect of the disclosure, the use conditions may include a usable time or an unusable time in a facility or a store which is the target place.

A second aspect of the disclosure relates to a non-transitory computer-readable recording medium storing a program executed by a computer. The program includes a step of acquiring a plurality of pieces of action schedule information each including a target place, a desired arrival time, and a desired stay time from a user, a step of acquiring use conditions of the target place included in each of the pieces of action schedule information, a step of acquiring a travel time between the target places, and a step of deciding a scheduled time of arrival at each target place based on the travel time between the target places such that the desired arrival time and the desired stay time included in each of the pieces of action schedule information satisfy usable conditions derived from the use conditions.

According to the aspects of the disclosure, it is possible to improve convenience at the time of deciding scheduled times of arrival at a plurality of target places.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram illustrating a configuration of an information processing system according to a first embodiment;

FIG. 2 is a block diagram illustrating a configuration of a server device of FIG. 1;

FIG. 3 is a diagram illustrating an example of an action schedule which is input to a terminal device of FIG. 1 by a user;

FIG. 4 is a diagram illustrating business hours of each target place and first to third travel times which are included in action schedule information of FIG. 3;

FIG. 5 is a diagram illustrating an example of an alternative action schedule which is created by a scheduling unit based on the action schedule of FIG. 3;

FIG. 6 is a flowchart illustrating processing in the server device of FIG. 1; and

FIG. 7 is a block diagram illustrating a configuration of a terminal device according to a second embodiment.

### DETAILED DESCRIPTION OF EMBODIMENTS

### First Embodiment

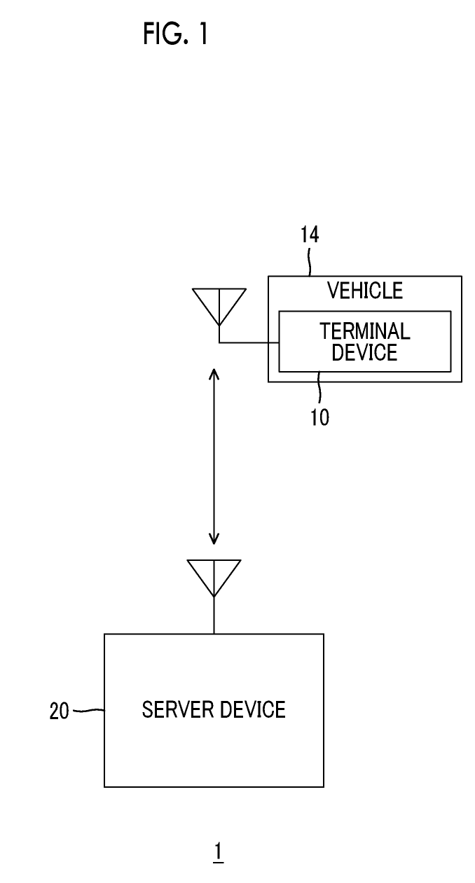

FIG. 1 is a block diagram illustrating a configuration of an information processing system 1 according to a first embodiment. The information processing system 1 includes a terminal device 10 and a server device 20. Here, for clarification of description, an example in which one terminal device 10 is provided is described, but the information processing system 1 may include a plurality of terminal devices 10.

The terminal device 10 is a car navigation device mounted on a vehicle 14 which is an automobile, or the like. The terminal device 10 may not be mounted on the vehicle 14, or may be a portable device, such as a smartphone, a mobile phone, a tablet device, a notebook computer, or a wearable device, which is carried by a user. The terminal device 10 may be a stationary terminal device such as a desktop personal computer.

The terminal device 10 performs wireless communication with the server device 20. The standard of wireless communication is not particularly limited, and includes, for example, a third generation (3G) mobile communication system, a fourth generation (4G) mobile communication system, or a fifth generation (5G) mobile communication system. The terminal device 10 may perform wireless communication with the server device 20 through a base station (not shown). In a case where the terminal device 10 is a desktop personal computer or the like, the terminal device 10 may perform wired communication with the server device 20.

The terminal device 10 receives an input of information on an action schedule from the user. Specifically, the terminal device 10 receives inputs of departure place information, return place information, transportation means information used for travel, and date information for executing an action schedule and receives a plurality of inputs of action schedule information from the user. The departure place information includes a departure place and a time of departure. The return place information includes a return place and a time of return. The departure place and the return place are the user's own home, a hotel, or the like. The action schedule information includes a target place, a desired arrival time, and a desired stay time. The target place is a store, a facility, or the like. It is assumed that the user inputs the action schedule information to a calendar displayed on the terminal device 10 on the day before departure, before departure on the day of departure, or the like.

At least one piece of action schedule information may further include change prohibition information on a scheduled time of arrival. The change prohibition information on the scheduled time of arrival is set to be action schedule information having a principal scheduled time of arrival by the user.

At least two pieces of action schedule information may further include pieces of change prohibition information of a before-after relation. The change prohibition information of a before-after relation is set to be pieces of action schedule information having a principal before-after relation of scheduled times of arrival by the user. The pieces of action schedule information including the pieces of change prohibition information of a before-after relation may be temporally adjacent to each other.

The departure place information may further include change prohibition information of a time of departure. The return place information may further include change prohibition information of a time of return. The change prohibition information of a time of departure and the change prohibition information of a time of return are set by the user.

The terminal device 10 transmits the input information on the action schedule to the server device 20. Information for identifying the terminal device 10 serving as a transmission source is attached to the transmitted information on the action schedule.

The server device 20 is installed at, for example, a data center, and processes the information on the action schedule which is transmitted from the terminal device 10 to function as an information processing device that determines a possibility of executing an action schedule, and the like.

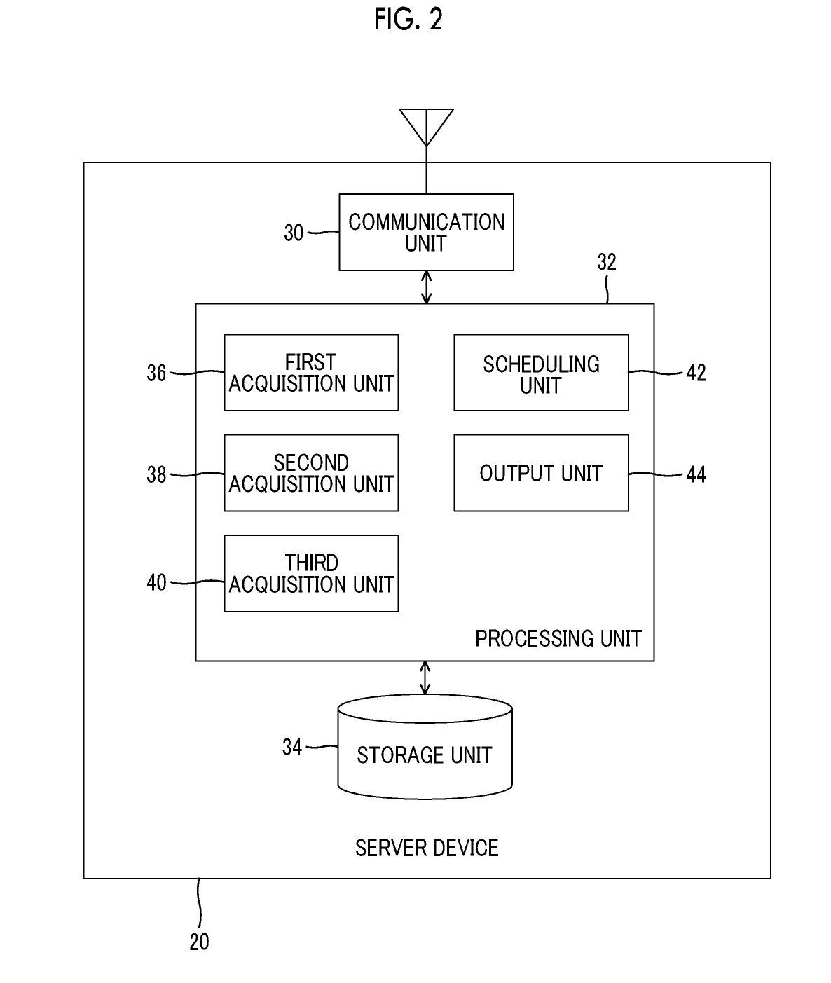

FIG. 2 is a block diagram illustrating a configuration of the server device 20 of FIG. 1. The server device 20 includes a communication unit 30, a processing unit 32, and a storage unit 34. The processing unit 32 includes a first acquisition unit 36, a second acquisition unit 38, a third acquisition unit 40, a scheduling unit 42, and an output unit 44.

The communication unit 30 performs wireless communication with the terminal device 10. The communication unit 30 receives information on the action schedule from the terminal device 10. The communication unit 30 outputs the information on the action schedule to the first acquisition unit 36.

The first acquisition unit 36 acquires the information on the action schedule which is received by the communication unit 30. The above-described configuration is an example of a configuration in which the first acquisition unit 36 acquires, from the user, first action schedule information including a first target place, a first desired arrival time when the user desires to arrive at the first target place, and a first desired stay time for which the user stays in the first target place, and second action schedule information including a second target place, a second desired arrival time when the user desires to arrive at the second target place, and a second desired stay time for which the user stays in the second target place. The first acquisition unit 36 stores the acquired information on the action schedule in the storage unit 34.

The second acquisition unit 38 acquires use conditions of a target place included in each action schedule information through the Internet from a server (not shown), or the like. The use conditions include time for which a facility or store being the target place is usable (that is, business hours) on a date when the action schedule is executed, or time for which the facility or store being the target place is unusable on the date. The second acquisition unit 38 stores the acquired use conditions of the target place included in the action schedule information in the storage unit 34.

The third acquisition unit 40 acquires a travel time (hereinafter, also referred to as “a first travel time”) between target places included in the action schedule information, a travel time (hereinafter, also referred to as “a second travel time”) from a departure place to a target place included in each action schedule information, and a travel time (hereinafter, also referred to as “a third travel time”) from a target place to a return place included in each action schedule information, through the Internet from a server (not shown) or the like. The first to third travel times are times in a case where a transportation means included in the information on the action schedule is used. In a case where the transportation means is an automobile, the first to third travel times are derived in consideration of the prediction of congestion on a road at a time of travel. The first to third travel times may vary depending on a date, or mat also vary depending on a time of travel. The third acquisition unit 40 stores the acquired first to third travel times in the storage unit 34.

The scheduling unit 42 determines whether or not the user can arrive at the target place included in each action schedule information by the desired arrival time and whether or not the user can arrive at the return place by the time of return, based on the first to third travel times. The scheduling unit 42 determines whether or not the desired arrival time and the desired stay time included in each action schedule information satisfy usable conditions derived from the use conditions.

The scheduling unit 42 outputs information indicating that the action schedule is executable to the output unit 44, in a case where the user can arrive at the target place included in each action schedule information by the desired arrival time, the user can arrive at the return place by the time of return, and the desired arrival time and the desired stay time included in each action schedule information satisfy usable conditions, that is, the action schedule is executable. The output unit 44 outputs information indicating that the action schedule is executable to the terminal device 10 through the communication unit 30. That is, the communication unit 30 transmits the information to the terminal device 10.

On the other hand, the scheduling unit 42 schedules the action schedule information in a case where the action schedule is not executable. Specifically, the scheduling unit 42 decides the scheduled time of arrival at each target place based on travel times between target places such that the desired arrival time and the desired stay time included in each action schedule information satisfy usable conditions in a case where the action schedule is not executable. In this case, the scheduling unit 42 may decide the scheduled time of arrival at each target place such that the sum of the travel times between the target places is minimized. The scheduling unit 42 decides the scheduled time of arrival at each target place without changing the scheduled time of arrival at the target place included in the action schedule information including the change prohibition information of the scheduled time of arrival. The scheduling unit 42 decides the scheduled time of arrival at each target place without changing the before-after relation of scheduled times of arrival at target places included in at least two pieces of action schedule information including the pieces of change prohibition information of a before-after relation. The scheduling unit 42 decides the scheduled time of arrival at each target place without changing the scheduled times of arrival at the via-places before and after the target place in a course toward the target place included in one of two pieces of action schedule information.

The scheduling unit 42 may decide the scheduled time of arrival at each target place by changing the time of departure from the departure place in a case where the departure place information does not include change prohibition information of a time of departure. The scheduling unit 42 decides the scheduled time of arrival at each target place also in consideration of the second travel time without changing the time of departure from the departure place in a case where the departure place information includes change prohibition information of a time of departure.

The scheduling unit 42 decides the scheduled time of arrival at each target place by changing the time of return from the return place in a case where the return place information does not include change prohibition information of a time of return. The scheduling unit 42 decides the scheduled time of arrival at each target place also in consideration of the third travel time so as to arrive at the return place by the time of return without changing the time of return from the return place in a case where the return place information includes change prohibition information of a time of return.

The scheduling unit 42 stores information on an alternative action schedule including the decided scheduled time of arrival at each target place, in the storage unit 34. The information on the alternative action schedule also includes information indicating that the action schedule input by the user is not executable.

The scheduling unit 42 decides the scheduled time of arrival at each target place such that the sum of the travel times between target places is minimized, in a case where the scheduled time of arrival at each target place cannot be decided such that the desired arrival time and the desired stay time included in each action schedule information satisfy usable conditions, and specifies the target place in which the desired arrival time and the desired stay time do not satisfy the usable conditions. The scheduling unit 42 stores the decided scheduled time of arrival at each target place and information on another action schedule including specification information on the target place in which the desired arrival time and the desired stay time do not satisfy usable conditions, in the storage unit 34. The information on the other action schedule also includes information indicating that the action schedule input by the user is not executable and indicating that an executable alternative action schedule cannot be created.

The output unit 44 outputs the information on the alternative action schedule or the information on the other action schedule which is stored in the storage unit 34 to the terminal device 10 through the communication unit 30. That is, the communication unit 30 transmits the information on the action schedule to the terminal device 10.

Referring back to FIG. 1, the terminal device 10 receives the information indicating that the action schedule is executable, the information on the alternative action schedule, or the information on the other action schedule which is transmitted from the communication unit 30. In a case where the terminal device 10 receives the information indicating that the action schedule is executable, the terminal device displays letters or the like indicating that the action schedule input by the user is executable. In a case where the terminal device 10 receives the information on the alternative action schedule, the terminal device displays letters or the like indicating that the action schedule input by the user is not executable and displays an image or the like indicating the alternative action schedule, based on the information.

In a case where the terminal device 10 receives the information on the other action schedule, the terminal device displays letters or the like indicating that the action schedule input by the user is not executable and displays letters or the like indicating that an executable alternative action schedule cannot be created, and displays an image or the like indicating the other action schedule. The other action schedule is displayed such that the target place in which the desired arrival time and the desired stay time do not satisfy usable conditions cannot be specified.

The above-described configuration can be realized by a Central Processing Unit (CPU), a memory, and other Large Scale Integration (LSI) of any computer in terms of hardware, and is realized by programs loaded into the memory, and the like in terms of software. Here, functional blocks realized by the association of the components are shown. Therefore, one skilled in the art can understand that the above-described functional blocks are realized in various ways by solely hardware, solely software, or a combination of hardware and software.

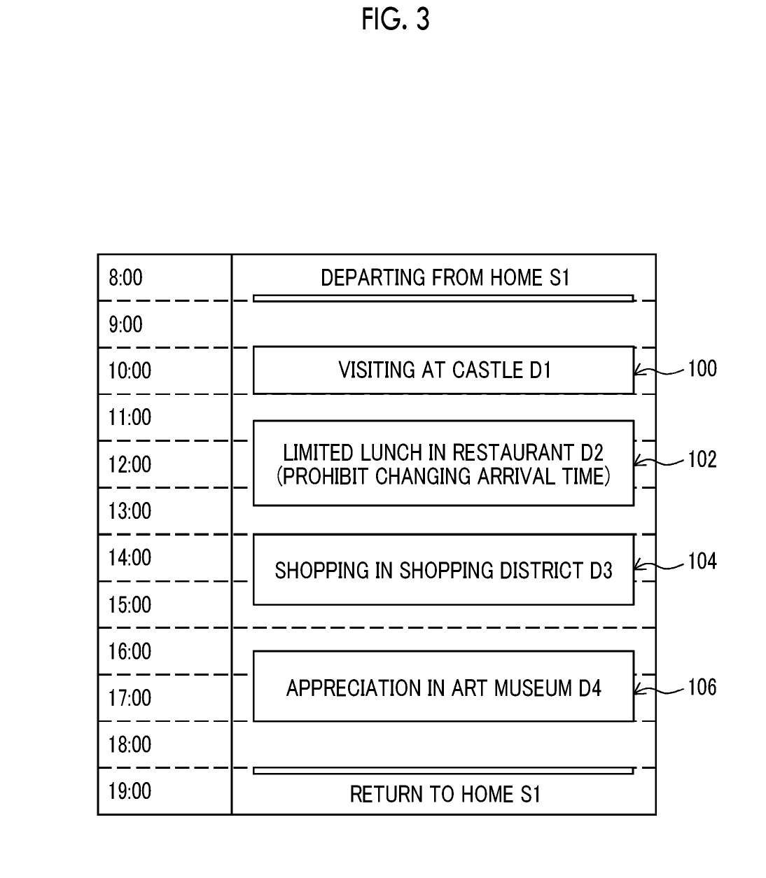

FIG. 3 is a diagram illustrating an example of the action schedule input to the terminal device 10 of FIG. 1 by the user. FIG. 3 illustrates an example of a display screen of the terminal device 10 displaying the action schedule. In the example of FIG. 3, the time of departure from the user's home S1 which is the departure place is 09:00 a.m., and the time of return to the user's home S1 which is the return place is 19:00 p.m. Departure place information does not include change prohibition information of the time of departure. Return place information includes change prohibition information of the time of return. The action schedule includes four pieces of action schedule information 100, 102, 104, and 106. In the action schedule information 100, the target place is a castle D1, the desired arrival time is 10:00 a.m., and the desired stay time is an hour. In the action schedule information 102, the target place is a restaurant D2, the desired arrival time is 11:30 a.m., and the desired stay time is two hours. Since limited lunch is reserved in the restaurant D2, change prohibition information of the desired arrival time is included in the action schedule information 102. In the action schedule information 104, the target place is a shopping district D3, the desired arrival time is 14:00 p.m., and the desired stay time is an hour and a half. In the action schedule information 106, the target place is an art museum D4, the desired arrival time is 16:30 p.m., and the desired stay time is an hour and a half.

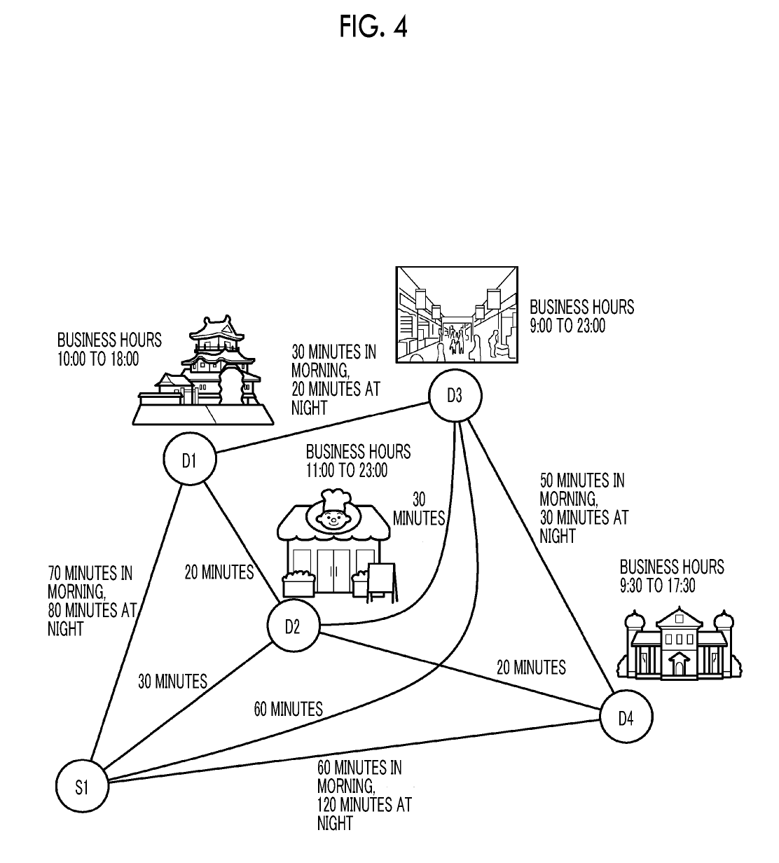

FIG. 4 is a diagram illustrating business hours of the target places included in the pieces of action schedule information 100 to 106 of FIG. 3, and first to third travel times. The desired arrival time (16:30 p.m.) and the desired stay time (an hour and a half) for the art museum D4 in FIG. 3 do not satisfy usable conditions (09:30 a.m. to 17:30 p.m.) for the art museum D4 in FIG. 4. A travel time from the art museum D4 to the user's home S1 at night is 120 minutes, and thus the user cannot meet the time of return (19:00 p.m.). Consequently, as described above, the scheduling unit 42 determines that the action schedule in FIG. 3 is not executable, and decides the scheduled time of arrival at each target place such that the desired arrival time and the desired stay time included in each action schedule information satisfy usable conditions. The action schedule information 102 includes change prohibition information of the scheduled time of arrival, and thus the scheduled time of arrival at the target place included in the action schedule information 102, that is, the restaurant D2 is not changed. The departure place information does not include change prohibition information of a time of departure, and thus the time of departure from the user's home S1 may be changed. The return place information includes change prohibition information of a time of return, and thus the time of return to the user's home S1 is not changed.

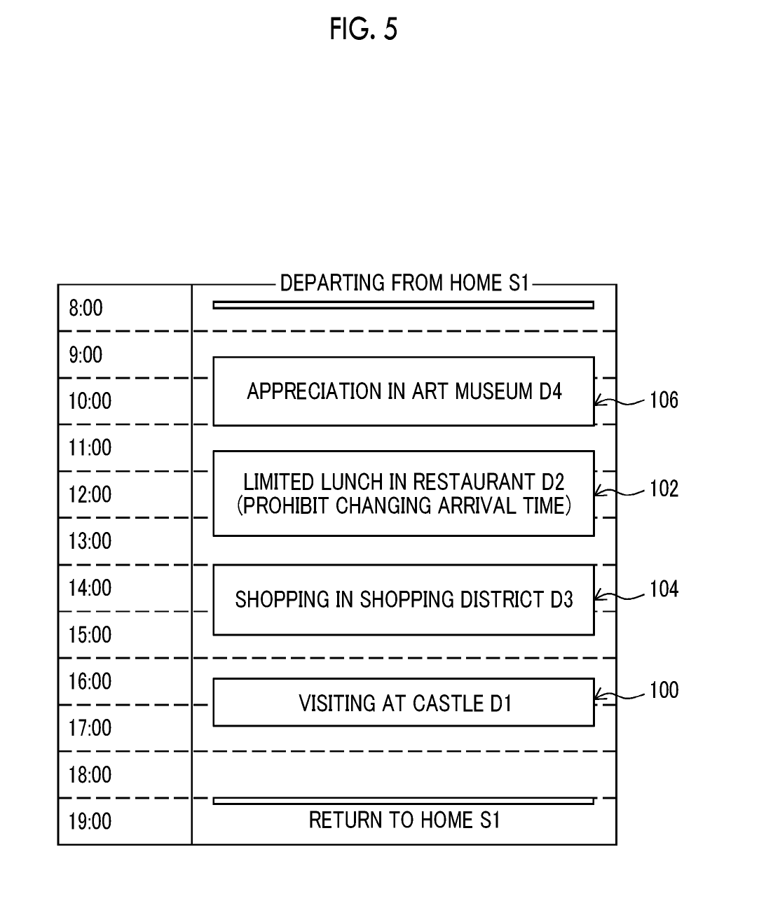

FIG. 5 is a diagram illustrating an example of an alternative action schedule created by the scheduling unit 42 based on the action schedule of FIG. 3. The action schedule information 100 and the action schedule information 106 are exchanged with each other, and the desired arrival time and the desired stay time included in each of the pieces of action schedule information 100 to 106 satisfy usable conditions. The time of departure from the user's home S1 is advanced. The user can arrive at the user's home S1 by the time of return.

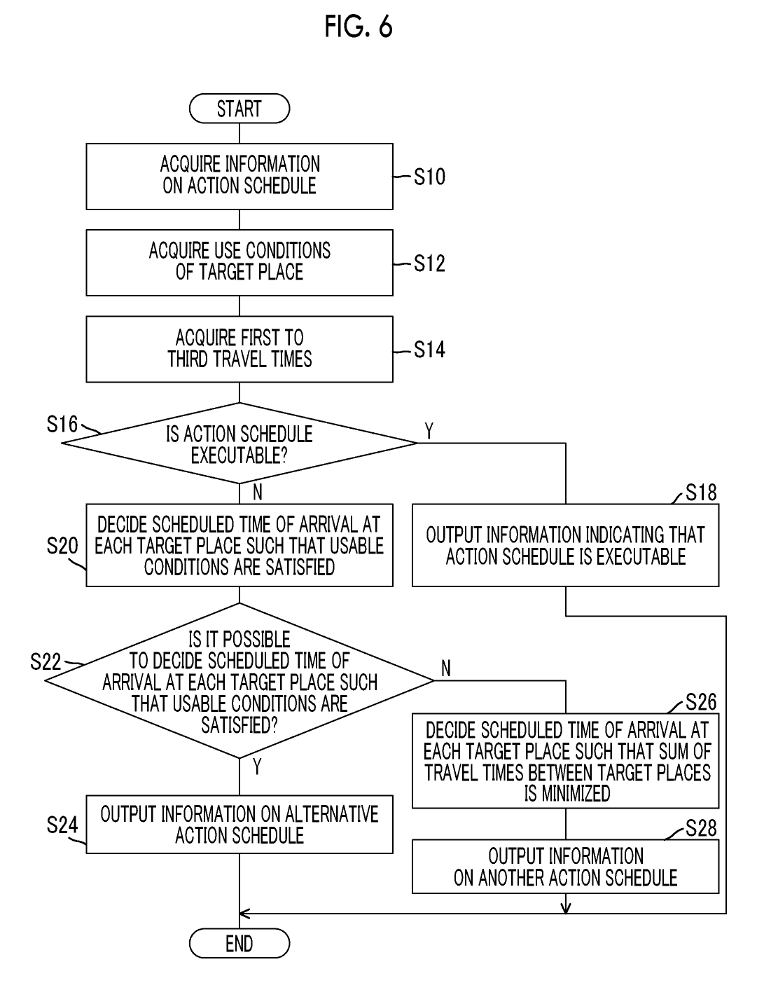

The overall operation of the information processing system 1 having the above-described configuration will be described. FIG. 6 is a flowchart illustrating processing in the server device 20 of FIG. 1. The first acquisition unit 36 acquires information of the action schedule from the terminal device 10 (S10). The second acquisition unit 38 acquires use conditions of the target place included in each action schedule information (S12). The third acquisition unit 40 acquires first to third travel times (S14). The scheduling unit 42 determines whether or not the action schedule is executable (S16). In a case where the action schedule is executable (Y in S16), the output unit 44 outputs information indicating that the action schedule is executable to the terminal device 10 (S18).

In a case where the action schedule is not executable (N in S16), the scheduling unit 42 decides the scheduled time of arrival at each target place such that usable conditions are satisfied (S20). In a case where it is possible to decide the scheduled time of arrival at each target place such that the usable conditions are satisfied (Y in S22), the output unit 44 outputs information on an alternative action schedule to the terminal device 10 (S24). In a case where it is not possible to decide the scheduled time of arrival at each target place such that the usable conditions are satisfied (N in S22), the scheduling unit 42 decides the scheduled time of arrival at each target place such that the sum of the travel times between the target places is minimized (S26). The output unit 44 outputs information on the other action schedule to the terminal device 10 (S28).

As described above, according to the first embodiment, the scheduled time of arrival at each target place is decided based on travel times between target places such that the desired arrival time and the desired stay time included in each action schedule information satisfy usable conditions, and thus it is possible to easily decide an appropriate scheduled time of arrival at each target place. Therefore, it is possible to improve convenience at the time of deciding scheduled times of arrival at a plurality of target places.

The scheduled time of arrival at each target place is decided without changing the scheduled time of arrival at the target place included in the action schedule information including change prohibition information of the scheduled time of arrival, and thus it is also possible to appropriately cope with a case where the target place for which the scheduled time of arrival is principal is included.

The scheduled time of arrival at each target place is decided without changing the before-after relation of scheduled times of arrival at target places included in at least two pieces of action schedule information including change prohibition information of a before-after relation, and thus it is also possible to appropriately cope with a case where target place for which the order of visiting is principal is included.

Further, the scheduled time of arrival at each target place is decided such that the sum of the travel times between target places is minimized, and thus it is possible to propose the action schedule with shorter travel times.

In a case where it is not possible to decide the scheduled time of arrival at each target place such that the desired arrival time and the desired stay time included in each action schedule information satisfies usable conditions, information on another action schedule in which the sum of the travel times between target places is minimized is output, and thus it is possible to make the user easily change the target place and the desired stay time based on the other action schedule.

### Second Embodiment

A second embodiment is different from the first embodiment in that most of the processing of the server device 20 in the first embodiment is performed by a terminal device 10. Hereinafter, differences from the first embodiment will be mainly described.

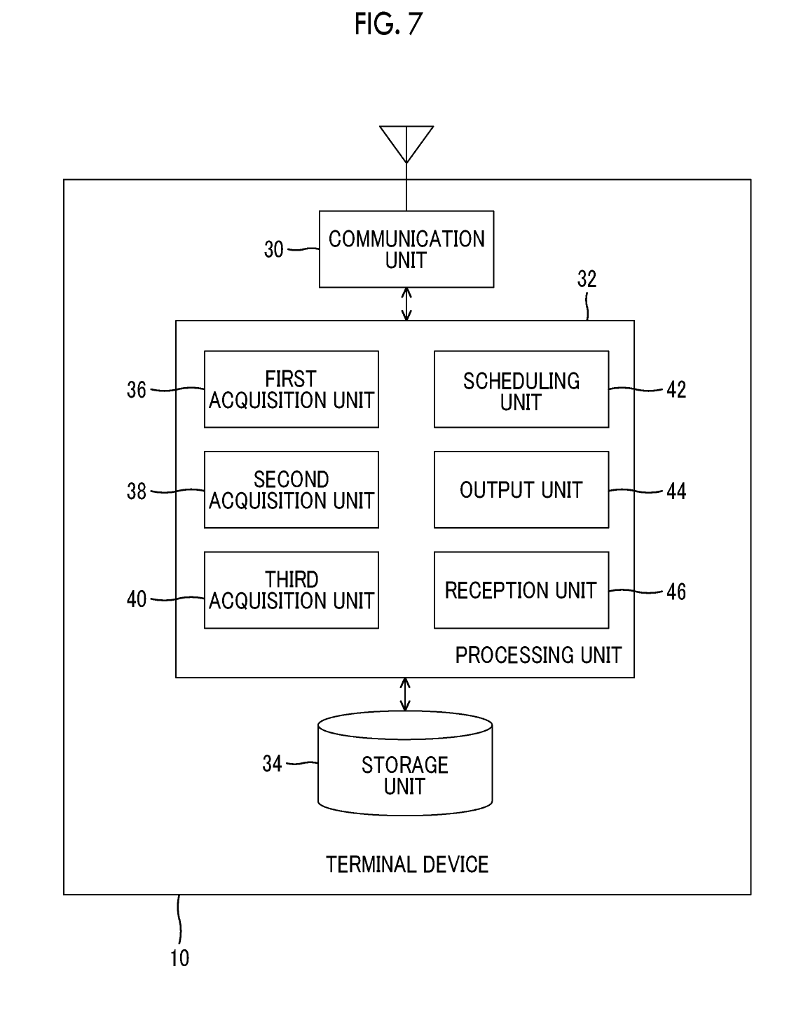

FIG. 7 is a block diagram illustrating a configuration of the terminal device 10 according to the second embodiment. The terminal device 10 functions as an information processing device. The terminal device 10 includes a communication unit 30, a processing unit 32, and a storage unit 34. The processing unit 32 includes a first acquisition unit 36, a second acquisition unit 38, a third acquisition unit 40, a scheduling unit 42, an output unit 44, and a reception unit 46.

The reception unit 46 receives an input of information on the action schedule from a user. The first acquisition unit 36 acquires the information on the action schedule received by the reception unit 46. The above-described configuration is an example of a configuration in which the first acquisition unit 36 acquires, from the user, first action schedule information including a first target place, a first desired arrival time when the user desires to arrive at the first target place, and a first desired stay time for which the user stays in the first target place, and second action schedule information including a second target place, a second desired arrival time when the user desires to arrive at the second target place, and a second desired stay time for which the user stays in the second target place. The first acquisition unit 36 causes the communication unit 30 to transmit information on each action schedule to the server device 20.

The server device 20 receives the information on each action schedule from the terminal device 10. The server device 20 acquires use conditions of the target place included in each action schedule information, and first to third travel times from a server (not shown) or the like through the Internet, similar to the first embodiment. The server device 20 transmits the acquired information to the terminal device 10.

The second acquisition unit 38 acquires use conditions of the target place included in each action schedule information from the server device 20 through the communication unit 30. The third acquisition unit 40 acquires first to third travel times from the server device 20 through the communication unit 30. The storage unit 34 stores the same information as that in the first embodiment. The scheduling unit 42 has the same function as that in the first embodiment.

In a case where the output unit 44 receives information indicating that the action schedule is executable from the scheduling unit 42, the output unit outputs letters or the like indicating that the action schedule input by the user is executable. In a case where information on an alternative action schedule is stored in the storage unit 34, the output unit 44 outputs letters or the like indicating that the action schedule input by the user is not executable, and outputs an image or the like indicating the alternative action schedule. In a case where information on another action schedule is stored in the storage unit 34, the output unit 44 outputs letters or the like indicating that the action schedule input by the user is not executable and indicating that an executable alternative action schedule cannot be created, and outputs an image or the like indicating the other action schedule.

According to the second embodiment, it is possible to increase the degree of freedom of a configuration of an information processing system 1 while obtaining the effects in the first embodiment.

Although the embodiments have been described as described above, the embodiments are just examples, and one skilled in the art can understand that various modification examples can be applied to combinations of components and processes.

For example, the scheduling unit 42 may advance the scheduled time of arrival at the next target place when a time between the time of departure from the target place and the scheduled time of arrival at the next target place is longer than the above-described travel time between the target places by a predetermined time or longer in a case where the action schedule is executable. The scheduling unit 42 executes a process of advancing the scheduled time of arrival at the next target place on each target place. The output unit 44 also outputs information on another action schedule including the advanced scheduled time of arrival at the target place. In the modification examples, it is possible to propose another action schedule allowing the user to visit all target places in a shorter period of time while maintaining the order of arrival at the target places, even in a case where the action schedule input by the user is executable.

The scheduling unit 42 may decide the scheduled time of arrival at each target place based on travel times between target places such that the sum of the travel times between the target places becomes smaller and the desired arrival time and the desired stay time included in each action schedule information satisfy usable conditions, in a case where the action schedule is executable. In this case, as described above, change prohibition information of the scheduled time of arrival, change prohibition information of a before-after relation, and change prohibition information of a time of return are also taken into consideration. The output unit 44 also outputs information on another action schedule including the decided scheduled time of arrival at each target place. In a case where the sum of the travel times between the target places does not become smaller, the scheduling unit 42 outputs information indicating that the sum of the travel times between the target places has not become smaller to the output unit 44. The above-described configuration is an example of a case where the action schedule input by the user is optimal. In the modification examples, it is possible to propose another action schedule allowing the user to visit all target places in a shorter period of time while changing the order of arrival at the target places, even in a case where the action schedule input by the user is executable.

What is claimed is:

1. An information processing device comprising:
a first acquisition unit configured to acquire, from a user,
first action schedule information including a first target place, a first desired arrival time when the user desires to arrive at the first target place, and a first desired stay time for which the user stays in the first target place, and
second action schedule information including a second target place, a second desired arrival time when the user desires to arrive at the second target place, and a second desired stay time for which the user stays in the second target place;
a second acquisition unit configured to acquire a first use condition of the first target place included in the first action schedule information, and a second use condition of the second target place included in the second action schedule information;
a third acquisition unit configured to acquire a travel time between the first target place and the second target place; and
a scheduling unit configured to decide a first scheduled time of arrival at the first target place and a second scheduled time of arrival at the second target place based on the travel time between the first target place and the second target place such that the first desired arrival time and the first desired stay time included in the first action schedule information satisfy a first usable condition derived from the first use condition and such that the second desired arrival time and the second desired stay time included in the second action schedule information satisfy a second usable condition derived from the second use condition.

2. The information processing device according to claim 1, wherein:
the second action schedule information further includes change prohibition information of the second desired arrival time, and
the scheduling unit decides the second desired arrival time as the second scheduled time of arrival, and decides the first scheduled time of arrival of the first target place instead of the first desired arrival time of the first target place, without changing the second desired arrival time of the second target place included in the second action schedule information including change prohibition information of the second desired arrival time.

3. The information processing device according to claim 2, wherein:
the first action schedule information further includes change prohibition information of scheduled times of arrival at via-places before and after the first target place, in a course toward the first target place included in the first action schedule information, and
the scheduling unit decides the first scheduled time of arrival at the first target place without changing the scheduled times of arrival at the via-places.

4. The information processing device according to claim 1, wherein:
the first action schedule information further includes change prohibition information of scheduled times of arrival at via-places before and after the first target place, in a course toward the first target place included in the first action schedule information, and
the scheduling unit decides the first scheduled time of arrival at the first target place and the second scheduled time of arrival at the second target place without changing the scheduled times of arrival at the via-places.

5. The information processing device according to claim 1, wherein the scheduling unit decides the first scheduled time of arrival at the first target place and the second scheduled time of arrival at the second target place such that a sum of the travel times between the first target place and the second target place is minimized.

6. The information processing device according to claim 5, wherein in a case where the scheduling unit is not able to decide the first scheduled time of arrival at the first target place and the second scheduled time of arrival at the second target place such that the first desired arrival time and the first desired stay time included in the first action schedule information satisfy the first usable condition derived from the first use condition and such that the second desired arrival time and the second desired stay time included in the second action schedule information satisfy the second usable condition derived from the second use condition, the scheduling unit decides the first scheduled time of arrival at the first target place and the second scheduled time of arrival at the second target place such that the sum of the travel times between the first target place and the second target place is minimized.

7. The information processing device according to claim 1, wherein the use conditions include a usable time or an unusable time in a facility or a store which is the target place.

8. A non-transitory computer-readable recording medium storing a program executed by a computer, the program comprising:
a step of acquiring a plurality of pieces of action schedule information each including a target place, a desired arrival time, and a desired stay time from a user;
a step of acquiring use conditions of the target place included in each of the pieces of action schedule information;
a step of acquiring a travel time between the target places; and
a step of deciding a scheduled time of arrival at each target place based on the travel time between the target places such that the desired arrival time and the desired stay time included in each of the pieces of action schedule information satisfy usable conditions derived from the use conditions.
